(19) United States
(12) Patent Application Publication
(10) Pub. No.: US 2012/0200998 A1
(43) Pub. Date: Aug. 9, 2012

(54) MOBILE COMPUTING DEVICE WITH MOVEABLE HOUSING SEGMENTS

(76) Inventors: Giancarlo Anthony GIUSTINA, San Francisco, CA (US); Ricardo Penate, Pacifica, CA (US); Wing K. (Chris) Ho, Cupertino, CA (US)

(21) Appl. No.: 13/170,986

(22) Filed: Jun. 28, 2011

Related U.S. Application Data
(60) Provisional application No. 61/440,856, filed on Feb. 8, 2011.

(51) Int. Cl. G06F 1/16

(52) U.S. Cl. 361/679.55

(57) ABSTRACT

A slider assembly for a computing device to interconnect at least two housing segments is disclosed. The first housing segment provides a first base plate and the second housing segment provides a second base plate. The slider assembly interconnects the two housing segments so that the segments may move about each other between a contracted and extended position. The slider assembly includes a rail that is provided with the first base plate and that engages a structure that is provided with the second base plate. The rail is enabled to move between one of the contracted or extended position. The slider assembly also includes a ground spring to maintain contact between the second base plate the rail.

### RELATED APPLICATIONS

This application claims the benefit of priority under 35 U.S.C. 119(e) to Provisional Application Ser. No. 61/440,856, filed Feb. 8, 2011, titled MOBILE COMPUTING DEVICE WITH MOVEABLE HOUSING SEGMENTS, and incorporates by reference U.S. patent application Ser. No. 11/971,136, filed on Jan. 8, 2008, titled MOBILE COMPUTING DEVICE WITH MOVEABLE HOUSING SEGMENTS, each of which is hereby incorporated by reference in its entirety.

### TECHNICAL FIELD

The disclosed embodiments relate generally to the field of housings for mobile computing devices. In particular, embodiments described herein pertain to a mobile computing device that has a housing construction with moveable housing segments.

### BACKGROUND

Over the last several years, the growth of cell phones and messaging devices has increased the need for keypads and button/key sets that are small and tightly spaced. In particular, small form-factor keyboards, including QWERTY layouts, have become smaller and more tightly spaced. With decreasing overall size, there has been greater focus on efforts to provide functionality and input mechanisms more effectively on the housings.

In addition to a keyboard, mobile computing devices and other electronic devices typically incorporate numerous buttons to perform specific functions. These buttons may be dedicated to launching applications, short cuts, or special tasks such as answering or dropping phone calls. The configuration, orientation and positioning of such buttons is often a matter of concern, particularly when devices are smaller.

At the same time, there has been added focus to how displays are presented, particularly with the increased resolution and power made available under improved technology. Moreover, form factor consideration such as slimness and appearance are important in marketing a device.

Production of mobile computing devices is made more difficult in the fact that conventional devices use many parts or components. The housing for a typical conventional mobile computing device typically includes a top shell, a back shell, and a midframe. The components that comprise the contents of the housing, such as printed circuit boards and display assemblies, normally require additional assembly steps. Many devices include additional housing features that are provided on the device separately. The result is that the devices often have numerous interconnected components. In the case of the housing, the numerous components yield devices that are less durable and more difficult to assemble.

In order to increase the features and functionality on a computing device, many mobile computing devices employ a sliding construction between two segments of the housing. Typically, in a sliding construction, the housing of a computing device is separated into two distinct parts that are coupled to one another to slide. The parts of the housing can be extended or contracted, to reveal functionality and/or adjust the overall size of the computing device.

### BRIEF DESCRIPTION OF THE DRAWINGS

The disclosure herein is illustrated by way of example, and not by way of limitation, in the figures of the accompanying drawings and in which like reference numerals refer to similar elements, and in which:

FIG. 1 illustrates a mobile computing device that includes a housing construction that incorporates a slider assembly, according to one or more embodiments;

FIG. 2 is a perspective view of a slider assembly for a mobile computing device, according to an embodiment;

FIGS. 3A and 3B illustrate a mobile computing device having two housing segments, according to an embodiment.

FIG. 4 is hardware diagram for a mobile computing device that is configured to support any of the embodiments described herein.

### DETAILED DESCRIPTION

Embodiments described herein provide a slider assembly to interconnect two housing segments of a mobile computing device. The slider assembly is structured to enable the housing segments to move between an extended and contracted position. Among other benefits, the slider assembly may provide one or more ground springs that are positioned within a region of a retaining structure to provide an electrical ground path between plates of the two housing segments.

In particular, each of the housing segments of the mobile computing device includes a base plate. A rail is provided with the first base plate and is engaged to a structure that is provided with the second base plate. In this manner, the slider assembly enables the rail to move or slide, thereby enabling the two housing segments to move between an extended or contracted position.

According to one or more embodiments, the mobile computing device may include a second slider assembly that includes a second rail and a second structure to engage the second rail. The second slider assembly may include a second ground spring that maintains contact between the second base plate and the second rail.

In some embodiments, the structure that is provided with the second base plate may include a cleat and an insert construction. The insert construction may be composed of a different material than the cleat and may be positioned in an overlaid portion of the cleat. The cleat may be structured so that it is angled along its length. The insert construction may be similarly structured to fit within the overlaid portion and further, may provide a means to engage the first rail. The insert construction may also have a recess or gap, in which the ground spring may be positioned.

In other embodiments, a slider assembly may have multiple ground springs. Each of the multiple ground springs are positioned to maintain contact between the second base plate and the first rail. The mobile computing device may also have two or more slider assemblies to enable a more effective smooth or stable sliding movement between the two housing segments.

As used herein, the term “substantially” means at least 90% of a stated reference, value or point of comparison. In the context of “substantially flush”, two thicknesses may be assumed to be about the same height, so as to be within 90% of one another, or alternatively within the manufacturing tolerances for producing the respective thicknesses.

### Overview

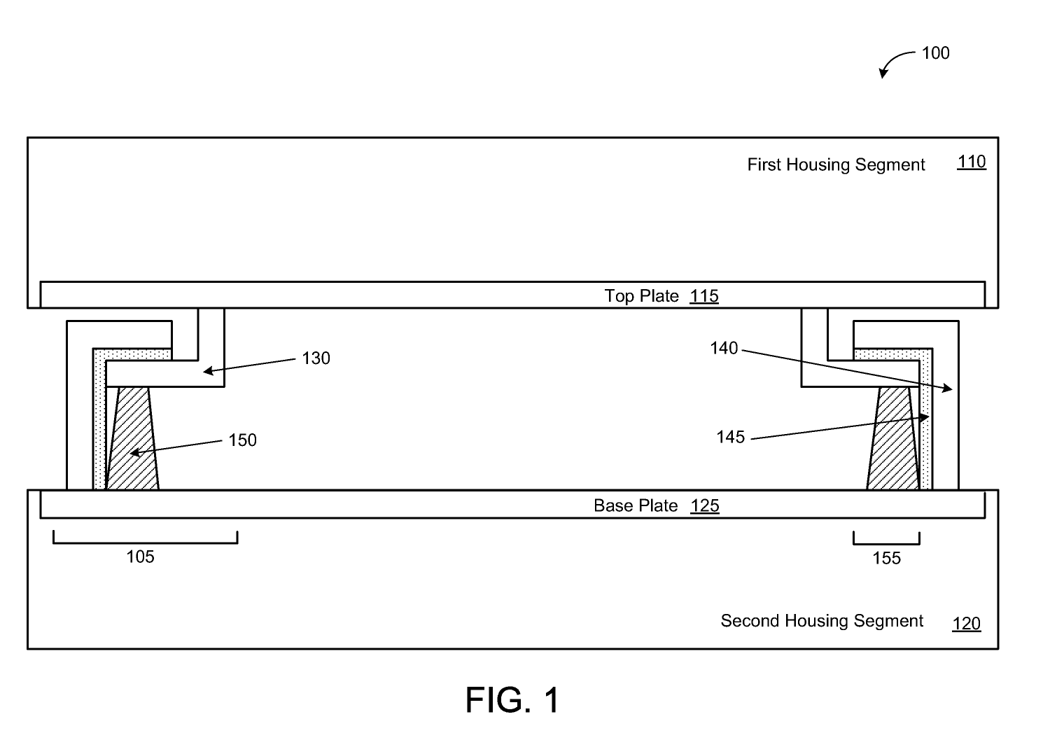

FIG. 1 illustrates a mobile computing device that includes a housing construction that incorporates a slider assembly, according to one or more embodiments. The mobile computing device 100 includes a slider assembly that interconnects the two housing segments of the mobile computing device and enables the housing segments to move between an extended and contracted position. The slider assembly also provides one or more ground springs that provide a electrical ground path between base plates of the two housing segments. The ground spring reduces the amount of electrical charge buildup in a base plate of a housing segment and reduces the potential for electrical shorts.

As examples, the mobile computing device 100 may correspond to any device that includes roaming wireless network and/or telephony capabilities, including cellular telephony devices and/or mobile messengers. In particular, embodiments described herein may apply to numerous kinds of mobile or small form-factor computing devices. One type of mobile computing device that may be configured to include embodiments described herein includes a computer telephony device, such as a cellular phone or mobile device with voice-telephony applications (sometimes called “smart phone”). A computing device such as described may be small enough to fit in one hand, while providing cellular telephony features in combination with other applications, such as messaging, web browsing, media playback, personal information management (e.g. such as contact records management, calendar applications, tasks lists), image or video/media capture and other functionality. Mobile computing devices in particular may have numerous types of input mechanisms and user-interface features, such as keyboards or keypads, mufti-directional or navigation buttons, application or action buttons, and contact or touch-sensitive display screens. Some devices may include combinations of keyboard, button panel area, and display screen on one fagade. The button panel region may occupy a band between the keypad and the display area, and include a navigation button and multiple application buttons or action buttons.

Specific types of messaging that may be performed include messaging for email applications, Short Message Service (SMS) messages, Multimedia Message Service (MMS) messages, and proprietary voice exchange applications (such as SKYPE). Still further, other types of computing devices contemplated with embodiments described herein include laptop or notebook computers, ultra-mobile computers, personal digital assistants, and other multi-functional computing devices or mobile/portable devices.

Still further, one or more embodiments may be implemented through any type of computing device such as a desktop computer that is configured to include real-time voice data exchange (e.g. through use of Internet Protocol telephony). Still further, other types of computer telephony devices exist, including standalone devices that connect directly to a telephone network (whether Internet Protocol or Public Switch Telephony System (PSTN)) and provide software interfaces and applications.

The mobile computing device 100 includes a first housing segment 110 and a second housing segment 120. In the illustrated embodiment, the mobile computing device 100 includes a pair of slider assemblies 105 that are configured to interconnect the first housing segment 110 and the second housing segment 120. The slider assembly 105 enables the two housing segments to move between a contracted position and an extended position (e.g., the device 100 is in a contracted position when the two housing segments are substantially overlapping or overlaying each other).

In some implementations, the first housing segment 110 includes a display surface and other user-interface features (e.g., buttons, sensors, touch-screen or area, microphone, speaker). The mobile computing device 100 may be operational in one or more modes when device 100 is in a contracted position. For example, the device 100 may be operated as a telephony device, picture viewer, web browser, media player, etc. The second housing segment 120 may include a keyboard in some embodiments, and the contracted position or orientation may be used to provide virtual keyboards or buttons to facilitate user operation.

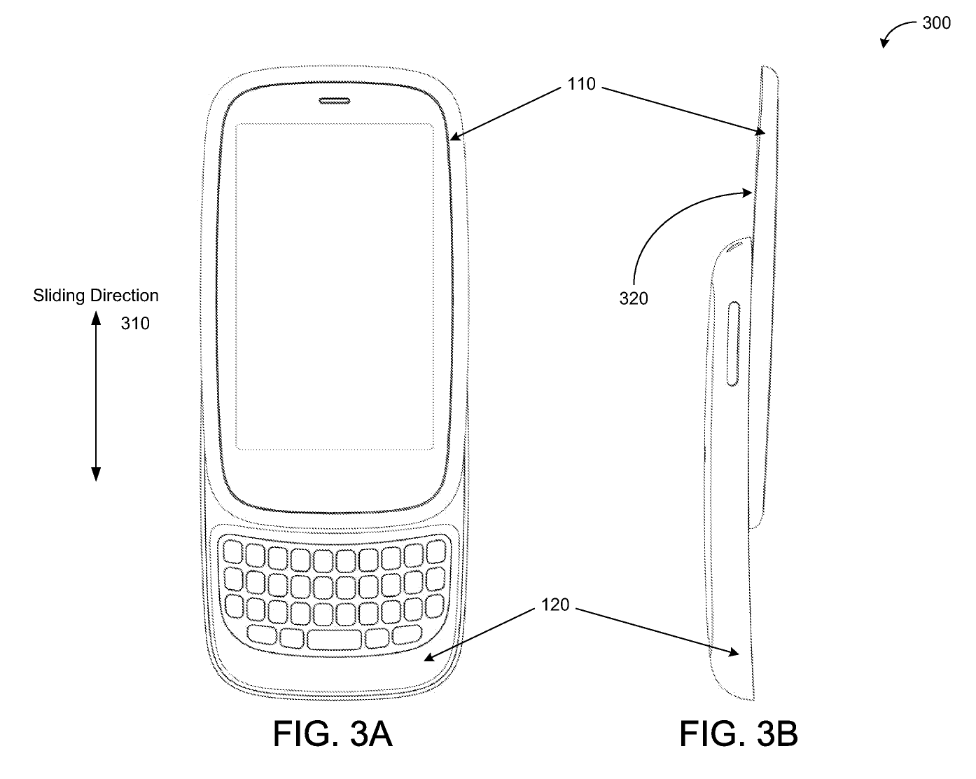

Each of the housing segments 110, 120 includes a base plate (for clarifying housing segments, the base plate of the first housing segment 110 has been called a top plate 115). The top plate 115 and the base plate 125 are positioned with the two housing segments 110, 120 to enable the slider assembly 105 to interconnect the two housing segments 110, 120. While the top plate 115 and the base plate 125 are illustrated to be positioned near the peripheral edge of the two housings segments 110, 120, respectively, the plates may be positioned so that the sides of the housing segments 110, 120 are substantially flush with each other. (see FIGS. 3A and 3B).

The slider assembly 105 is positioned between the top plate 115 and the base plate 125 to interconnect the two housing segments 110, 120. In an embodiment, the slider assembly 105 includes a rail 130 and a cleat structure 140. The rail 130 may include a slot and/or protrusion to engage with the cleat structure 140 and slide along its length. The rail 130 may also be fixed relative to one housing segment (illustrated in FIG. 1 as being fixed to the first housing segment 110). For example, rail 130 may be formed from an integral or affixed component of the top plate 115 or component that is provided as part of the first housing segment 110. By using the slider assembly 105, the top plate 115 may slideably move relative to the base plate 125 (e.g., the sliding direction would be in the direction going into the paper in FIG. 1).

In some embodiments, the slider assembly 105 may be positioned to be near the peripheral regions or surfaces of the housing segments 110, 120. As illustrated, two slider assemblies 105 are illustrated in FIG. 1, with each slider assembly being provided near the sides of the mobile computing device 100. In other embodiments, the slider assemblies 105 may be provided more towards the center or middle of the housing segments 110, 120. Having two slider assemblies 105, instead of one, may be beneficial to providing stability between the two housing segments 110, 120 regardless of the positioning or orientation of the housing segments 110, 120 (e.g., whether or not the device is in an extended or contracted position, having two slider assemblies makes it harder to twist or rotate the housing segments about each other).

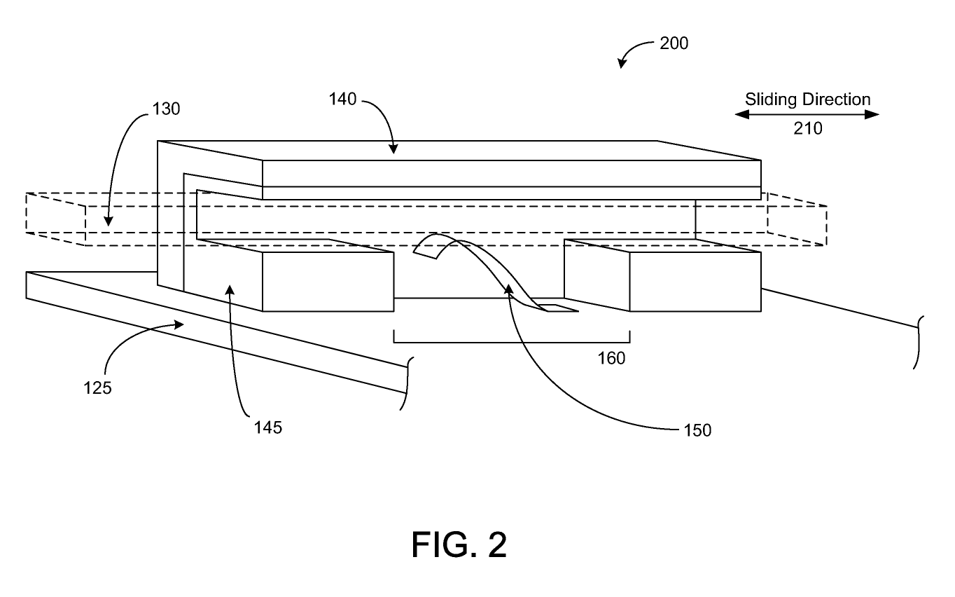

In addition to the rail 130, the slider assembly 105 also includes a cleat structure 140. The cleat structure 140 is shaped and angled along its length (see FIG. 2) to have an overlaid portion 155. In some embodiments, the cleat structure 140 includes or is provided with an insert construction or cleat insert 145. The cleat insert 145 may be composed of a different material than the cleat structure 140. For example, the cleat structure 140 may be composed of a metal, while the cleat insert 145 is composed of a plastic material. In one or more embodiments, the cleat insert 145 is provided within the overlaid portion 155 of the cleat structure 140 so that it abuts (or layers) the cleat structure 140. The cleat insert 145 may be joined together with the cleat structure 140 (the combination may be called a retaining structure, for example) with an adhesive or glue to prevent the cleat insert 145 from moving.

Like the rail 130, the cleat structure 140 may be fixed relative to one housing segment (illustrated in FIG. 1 as being fixed to the second housing segment 120). In some embodiments, the cleat structure 140 may be formed from an integral or affixed component of the base plate 125 or component that is provided as part of the second housing segment 120. The cleat structure 140 is configured to have an angled shape to enable the rail 130 to be slideably engaged to the cleat structure 140. The rail 130 may slide along the length of the cleat structure 140 and the cleat insert 145 smoothly. This enables the first housing segment 110 and the second housing segment 120 to move between a contracted position and an extended position.

The retaining structure (cleat structure 140 and the cleat insert 145) is structured to engage the rail 130 of the first housing segment 110. As discussed, a portion of the rail 130 is connected or fixed to the top plate 115 (e.g., welded with the top plate 115) while the other portion is engaged with the cleat structure 140 and the cleat insert 145. In this way, the rail 130 may fit into place underneath a portion of the cleat structure 140 and the cleat insert 145 in the overlaid portion 155. The size and/or thickness of the rail 130, and the size and/or thickness of the cleat structure 140 and the cleat insert 145 may be calculated/established to enable a smooth or stable sliding movement between the two housing segments 110, 120 (e.g., so that the mobile computing device 100 can move between the contracted and extended position easily).

In one or more embodiments, the cleat structure 140 may be angled (e.g., 90 degrees, as illustrated in FIGS. 1 and 2) to better engage the rail 130. In other embodiments, however, the cleat structure 140 may be angled more or less than 90 degrees depending on the design of the rail 130 and the mobile computing device 100. The cleat structure 140 may be angled 110 degrees, for example, or 70 degrees to be more acute in shape. Furthermore, the length of the cleat structure 140 and the rail 130 may be substantially the same size or may be different sizes. For example, the cleat structure 140 may be shorter in length than the rail 130 (see FIG. 2) to enable a longer extension position of the mobile computing device 100. In some embodiments, the rail 130 may be structured to have a different shape or figure (e.g., instead of an “L” shape, it can be a “T” shape) and the cleat structure 140 may have a shape to receive the rail 130.

The slider assembly 105 may also include one or more ground springs 150. A ground spring 150 may be used to create an electrical ground path between the two base plates (top plate 115 and base plate 125) of the mobile computing device 100. Because the mobile computing device 100 comprises two segments, one plate may have a buildup of electrical charge. To reduce the potential for electrical shorting, the ground spring 150 may be used to maintain contact between the two base plates 115, 125. In some embodiments, the ground spring 150 is positioned within the overlaid portion 155 of the cleat structure 140 so that the ground spring 150 is connected or fixed to the base plate 125 and also touches the rail 130.

The ground spring 150 may be a coil spring or flat spring, for example, and may comprise a material that makes the ground spring 150 move in an upward motion (e.g., due to spring tension). Thus, one portion of the ground spring 150 is connected or fixed (e.g., welded together) to the base plate 125, and the other portion, which is not fixed, can be pressed toward the rail 130. As discussed, because the rail 130 is connected to or fixed to the top plate 115, the ground spring 150 will maintain contact between the base plate 125 and the rail 130. The contact is maintained even though the rail 130 slideably moves between the contracted or extended position.

In some embodiments, the ground spring 150 may be positioned within the overlaid portion 155 of the cleat structure 140. The cleat insert 145, which is abut or layers portions of the cleat structure 140, is shaped and configured to have a recess or gap (see FIG. 2). While the recess or gap in FIG. 2 is illustrated as a rectangular prism, the recess or gap may also have different shapes and/or sizes. The ground spring 150 may be positioned within the overlaid portion 155 of the cleat structure 140 and within the recess or gap of the cleat insert 145. By placing the ground spring 150 within the overlaid portion 155, any streaks (or markings or scratches) due to the contact of the ground spring 150 to the rail 130 is not visible to a user (because the rail 130 is not visible to a user).

According to an embodiment, the slider assembly 105 may be configured to have a slight curvature along the its length so that the housing segments 110, 120 may slideably move between a contracted position and an extended position along a slight arc. In other implementations, the mobile computing device 100 may also include multiple slider assemblies 105 (e.g., four) that are positioned to be parallel to each other and/or positioned substantially equidistant from each other. The slider assemblies 105 may have a variety of different sizes and/or lengths.

FIG. 2 is a perspective view of a slider assembly for a mobile computing device, according to an embodiment. As discussed, a slider assembly 200 includes a rail 130 (shown in dotted lines for clarity in FIG. 2), a cleat structure 140, a cleat insert 145 and a ground spring 150. The rail 130 is illustrated as a rectangular prism in FIG. 2, but is angled and shaped to connect or be fixed with the top plate 115 (the top plate 115 is not shown in FIG. 2, but is shown in FIG. 1). The rail 130 is shaped to engage with the cleat structure 140 and the cleat insert 145 (the combination called a retaining structure) so that it may slideably move between a contracted or extended position (e.g., along the sliding direction 210).

The cleat insert 145 is provided within an overlaid portion 155 of the cleat structure 140. As discussed, the cleat insert 145 may be composed of a different material than the cleat structure 140 and may abut or layer some portions of the cleat structure 140. The cleat structure 140 and the cleat insert 145 may be shaped and configured to engage the rail 130 of the first housing segment. This enables the rail 130 to slideably move along the length of the cleat structure 140 and cleat insert 145, and thus, enables the housing segments to move about each other.

In some embodiments, the cleat insert 145 may also include a gap or recess 160 so that the ground spring 150 may be provided within the overlaid portion 155 (see FIG. 1) of the cleat structure 140. Although the ground spring 150 is illustrated as a flat spring, other variations and types of springs are possible. The ground spring 150, in this example, is connected or fixed (e.g., welded) to the base plate 125 of the second housing segment 120. However, one end of the ground spring 150 is free (e.g., is not fixed). The free end of the ground spring 150 makes contact with the rail 130 to create a ground path between the two base plates 115, 125 (the ground path is created because the rail 130 is conductive and is connected to the top plate 115).

According to some embodiments, the slider assembly 200 may include more than one ground spring 150. For example, the cleat insert 145 may be shaped to have two gaps or recesses 160, and a ground spring 150 may be positioned in each of the two gaps or recesses 160.

### Housing Assembly for Mobile Computing Device

FIGS. 3A and 3B illustrate a mobile computing device having two housing segments, according to an embodiment. FIG. 3B is a side view of the mobile computing device 300 in FIG. 3A. The mobile computing device 300 has a first housing segment 110 and a second housing segment 120. As discussed, a slider assembly moveably couples the housing segments 110, 120 between contracted and extended positions in order to expose additional user-interface features and/or functionality. The housing segments 110, 120 may change positions by sliding in the direction 130. In some embodiments, as discussed, the slider assembly may be configured to have a slight curvature along the its length so that the housing segments 110, 120 may slideably move between a contracted position and an extended position along a slight arc.

For example, in FIGS. 3A and 3B, the two housing segments 110, 120 are slideably moved so that the mobile computing device 100 is in an extended position. The underlying surface of the second housing segment 120 is fully exposed. In one implementation, a keyboard, for example, may be provided on the second housing segment 120. Other input mechanisms, user-interface features and functionality can also or alternatively be provided.

The housing segments 110, 120 are positioned so that their sides substantially line up and are substantially flush with each other. In addition, the housing segments 110, 120 are structured so that the sliding assembly is not visible to a user. As discussed, the ground spring of the sliding assembly may be positioned within the overlaid portion of the cleat structure. By placing the ground spring within the overlaid portion, any streaks (or markings or scratches) due to the contact of the ground spring to the rail is not visible to a user (because the rail 130 is not visible to a user). For example, if the ground spring was in a different location, such that the ground spring was in contact with the two base plates of the housing segments, a streak or marking may be seen on the backside 320 of the first housing segment 110. By placing the ground spring within the overlaid portion and only making contact with the rail of the slider assembly, the slider assembly enables an electrical ground path to be created and prevents unwanted (and aesthetically unpleasant) markings from forming.

### Hardware Diagram

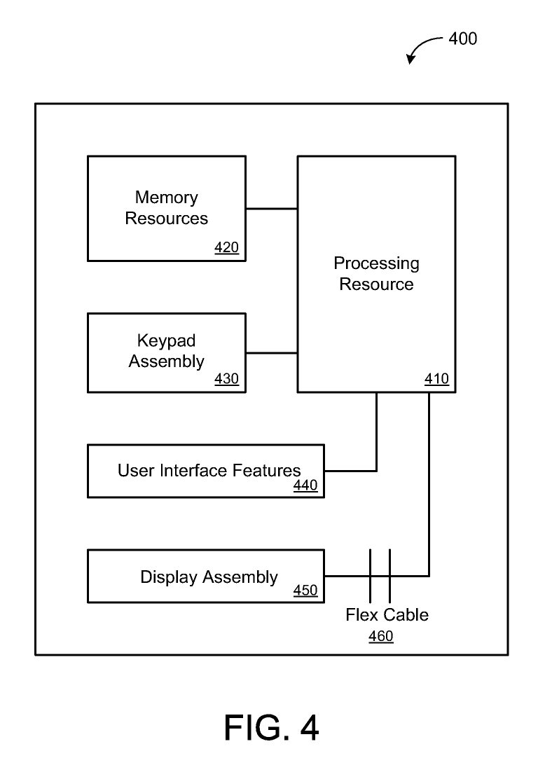

FIG. 4 illustrates a hardware diagram for a mobile computing device for use with any of the embodiments described herein. Numerous components and functionality may be incorporated for use with the device 400. The components include, for example, processors, memory components, interconnect elements, a printed circuit board, internal elements of a keypad of keyboard, a liquid crystal display (LCD) of a display assembly, speakers or other audio equipment, wireless transmitters for different types of wireless communication mediums (e.g., Wireless Fidelity or Wi-Fi, Bluetooth, Wi-Max cellular) and numerous other components.

According to an embodiment, the device 400 may correspond to any of the devices illustrated with preceding embodiments. The device 400 may include one or more processors 410, memory resources 420, a keypad assembly 430, various user-interface features 440, and a display assembly 450. In one embodiment, at least some of the components may be provided in a different housing segment from the one or more processors 410. The display assembly 450, for example, may be provided with a first housing segment, while the one or more processors 410 is provided with a second housing segment. A flex cable 460 may be used to interconnect the separated display assembly 450 and/or user-interface features 440 from the one or more processors 410 and/or other components. However, in other embodiments, any of the internal components and devices, including one of multiple processors, may be distributed between the two housing segments. The two housing segments of mobile computing device 400 may be slideably coupled together using a slider assembly (such as illustrated in FIGS. 1 and 2), as discussed.

In some embodiments, the display assembly 450 can comprise a touch screen display. The touch screen display can receive user input through contact on the display and communicate the information to the one or more processing resources 410. In other embodiments, the one or more processors 410 are capable of generating or detecting input from soft-interface features that are provided with the display assembly 450. The soft-user interface features may be provided as computer-generated features in connection with operation of the display assembly 450, or alternatively, as fixed features. One or more embodiments provide that the soft-user interface features may operate with touch, contact or light sensors (e.g., capacitive sensors).

### Alternative Embodiments

In one embodiments, referring to FIG. 1, the ground spring 150 may be connected or fixed to the underside of the rail 130 so that the free (not fixed) end of the ground spring 150 makes contact with the base plate. In some embodiments, the spring may be positioned on the upper portion of the cleat structure 140 and makes contact with the top plate 115. The various components of the slider assembly 105 may also be switched (e.g., the rail 130 may be connected to the base plate 125, while the cleat structure 140 is connected to the top plate 115). In addition, different electrical components may be housed in different housing segments depending on the mobile computing device. For instance, the first housing segment 110 may include a display assembly, while the second housing segment 120 includes the processing resource and a keyboard, or vice versa.

It is contemplated for embodiments described herein to extend to individual elements and concepts described herein, independently of other concepts, ideas or system, as well as for embodiments to include combinations of elements recited anywhere in this application. Although illustrative embodiments have been described in detail herein with reference to the accompanying drawings, it is to be understood that embodiments are not to be limited to those as exactly described. As such, many modifications and variations will be apparent to practitioners skilled in this art. Accordingly, it is intended that the scope of the invention be defined by the claims and their equivalents (whenever presented). Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

What is claimed is:

1. A mobile computing device comprising:
a first housing segment and a second housing segment that are slideably coupled to one another to move between a contracted position and an extended position, the first housing segment providing a first base plate and the second housing segment providing a second base plate; and
a slider assembly to interconnect the two housing segments, the slider assembly including (i) a first rail that is provided with the first base plate, the first rail being engaged to a first structure that is provided with the second base plate to enable the first rail to move between one of the contracted position or the extended position, and (ii) a ground spring to maintain contact between the second base plate and the first rail.

2. The mobile computing device of claim 1, further comprising a second slider assembly, the second slider assembly including (i) a second rail that is provided with the first base plate, and (ii) a second structure that is provided with the second base plate.

3. The mobile computing device of claim 2, wherein the second slider assembly further includes a second ground spring to maintain contact between the second base plate the second rail.

4. The mobile computing device of claim 1, wherein first structure includes (i) a cleat, and (ii) an insert construction.

5. The mobile computing device of claim 4, wherein the insert construction is (i) composed of a different material than the cleat, and (ii) positioned in an overlaid portion of the of the cleat.

6. The mobile computing device of claim 5, wherein the insert construction is configured to engage the first rail to enable the first rail to move between one of the contracted position or the extended position.

7. The mobile computing device of claim 6, wherein the ground spring is positioned within a first gap of the insert construction.

8. The mobile computing device of claim 7, wherein the slider assembly further includes a second ground spring to maintain contact between the second base plate and the first rail.

9. The mobile computing device of claim 8, wherein the second ground spring is positioned within a second gap of the insert construction.

10. A mobile computing device comprising:
a first housing segment having a first base plate;
a second housing segment having a second base plate;
two or more slider assemblies that moveably couple the first housing segment to the second housing segment;
wherein each of the one or more slider assemblies includes:
a rail provided with the first base plate;
a retaining structure provided with the second base plate, the retaining structure engaging the rail to enable the rail to move between one of a contracted position or an extended position; and
a ground spring positioned within an overlaid portion of the retaining structure to maintain contact between the second base plate and the rail.

11. The mobile computing device of claim 10, wherein the two or more slider assemblies are positioned parallel to each other.

12. The mobile computing device of claim 11, wherein the retaining structure includes (i) a cleat, and (ii) an insert construction.

13. The mobile computing device of claim 12, wherein the insert construction is (i) composed of a different material than the cleat, and (ii) positioned in an overlaid portion of the of the cleat.

14. The mobile computing device of claim 13, wherein the ground spring is positioned within a gap of the insert construction.
